(19) United States
(12) Patent Application Publication
(10) Pub. No.: US 2018/0197153 A1
(43) Pub. Date: Jul. 12, 2018

(54) ELECTRONIC CALENDARING AND TRAVELING FACILITY

(71) Applicant: INTERNATIONAL BUSINESS MACHINES CORPORATION, Armonk, NY (US)

(72) Inventors: Edward V. BUSCH, Raleigh, NC (US); Sae Ryun LIM, Raleigh, NC (US); Alison E. MILLER, Apex, NC (US); Martin J. PRESLER-MARSHALL, Chapel Hill, NC (US); Lakshminarayanan SRINIVASAN, Cary, NC (US)

(21) Appl. No.: 15/404,451

(22) Filed: Jan. 12, 2017

(51) Int. Cl. G06Q 10/10; G01C 21/34; G01C 21/20

(52) U.S. Cl. CPC G06Q 10/1095; G01C 21/3438; G01C 21/3453; G01C 21/3484; G01C 21/3415; G01C 21/20

(57) ABSTRACT

Electronic calendaring and travel monitoring are provided to facilitate alternate travel routing of an attendee(s) to a meeting. The approach includes receiving a meeting time and location, and ascertaining that multiple attendees are traveling to the meeting, including obtaining originating locations for the multiple attendees. The method also includes determining, based at least in part on respective originating locations and the meeting location, that at least one attendee traveling to the meeting is subject to a travel delay based on travel conditions, and is predicted to be delayed to the meeting. Further, at least one other attendee traveling to the meeting is notified that the at least one attendee is delayed, and one or more alternate travel routes for that other attendee(s) are generated based, at least in part, on an estimated delay of the at least one attendee, and on a specified attribute(s) for the alternate travel route(s).

### BACKGROUND

In a business context, an electronic calendar system maintains useful information for users, and allows maintenance of schedules of activities, such as a meeting times, meeting locations, etc.

Additionally, navigation systems, such as global positioning system (GPS) navigation systems, are commonly utilized by individuals to navigate to various destinations, including meeting destinations for business.

Conventionally, there is no interaction between an electronic calendar system used by users to track events, such as meeting appointments, and navigation systems used by the attendees to, for instance, travel from an originating location to a meeting location.

### SUMMARY

The shortcomings of the prior art are overcome and additional advantages are provided, in one or more aspects, through the provision of a computer-implemented method which includes: receiving, by an electronic system, a meeting time and meeting location for a meeting, and ascertaining, by the electronic system, that multiple attendees to the meeting are traveling to the meeting. The ascertaining includes obtaining originating locations for the multiple attendees traveling to the meeting. Further, the method includes determining, based at least in part on the respective originating locations and the meeting location, that at least one attendee traveling to the meeting is subject to a travel delay based on one or more travel conditions, and is predicted to be delayed to the meeting, and notifying at least one other attendee traveling to the meeting that the at least one attendee is predicted to be delayed to the meeting. In addition, the computer-implemented method generates one or more alternate travel routes for the at least one other attendee based, at least in part, on an estimated delay of the at least one attendee, and based on one or more specified attributes for the alternate travel route(s).

In another aspect, a system of electronic calendaring and travel monitoring is provided which includes a memory, and a processing circuit communicatively coupled with the memory. The system performs a method, including receiving a meeting time and meeting location for a meeting, and ascertaining that multiple attendees are traveling to the meeting. The ascertaining includes obtaining originating locations for the multiple attendees traveling to the meeting. The method further includes determining, based at least in part on the respective originating locations and the meeting locations, that at least one attendee traveling to the meeting is subject to a travel delay based on one or more travel conditions, and is predicted to be delayed to the meeting. In addition, the method includes notifying at least one other attendee traveling to the meeting that the at least one attendee is predicted to be delayed to the meeting, and generating one or more alternate travel routes for the at least one other attendee based, at least in part, on an estimated delay of the at least one attendee, and based on one or more specified attributes for the alternate travel route(s).

In a further aspect, a computer program product for electronic calendaring and travel monitoring is provided. The computer program product includes a computer readable storage medium readable by a processing circuit and storing instructions for execution by the processing circuit for performing a method. The method includes: receiving a meeting time and meeting location for a meeting, and ascertaining that multiple attendees to the meeting are traveling to the meeting. The method further includes determining, based at least in part on respective originating locations and the meeting location, that at least one attendee traveling to the meeting is subject to a travel delay based on travel conditions, and is predicted to be delayed to the meeting, and notifying at least one other attendee traveling to the meeting that the at least one attendee is predicted to be delayed to the meeting. The method further includes generating one or more alternate travel routes for the at least one other attendee based, at least in part, on an estimated delay of the at least one attendee, and based on one or more specified attributes for the alternate travel route(s).

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a network of data processing systems which may implement an electronic calendaring and travel monitoring, in accordance with one or more aspects of the present invention;

FIG. 2 is a block diagram of a data processing system in which electronic calendaring and travel monitoring may be implemented, in accordance with one or more aspects of the present invention;

FIG. 3 is a diagram illustrating one embodiment of system components for managing an electronic calendar system, in accordance with one or more aspects of the present invention;

FIG. 4 is a block diagram of one embodiment of an electronic system with a calendar and travel facility, in accordance with one or more aspects of the present invention;

FIG. 5 depicts one embodiment of a graphical user interface for creating a calendar entry in an electronic system, in accordance with one or more aspects of the present invention;

FIG. 6 depicts a further example of a graphical user interface with a calendar entry expanded to view individual traveling attendees' originating locations, in accordance with one or more aspects of the present invention;

FIG. 7 depicts one embodiment of a process for monitoring attendee travel and for providing one or more alternate travel route(s) should at least one traveling attendee be delayed, in accordance with one or more aspects of the present invention;

FIGS. 8A & 8B depicts an exemplary travel route change pursuant to processing in accordance with one or more aspects of the present invention;

FIG. 9 depicts one embodiment of a cloud computing environment, which may implement or be used in association with one or more aspects of the present invention; and

FIG. 10 depicts an example of extraction model layers, which facilitate or implement a calendar and travel facility, in accordance with one or more aspects of the present invention.

### DETAILED DESCRIPTION

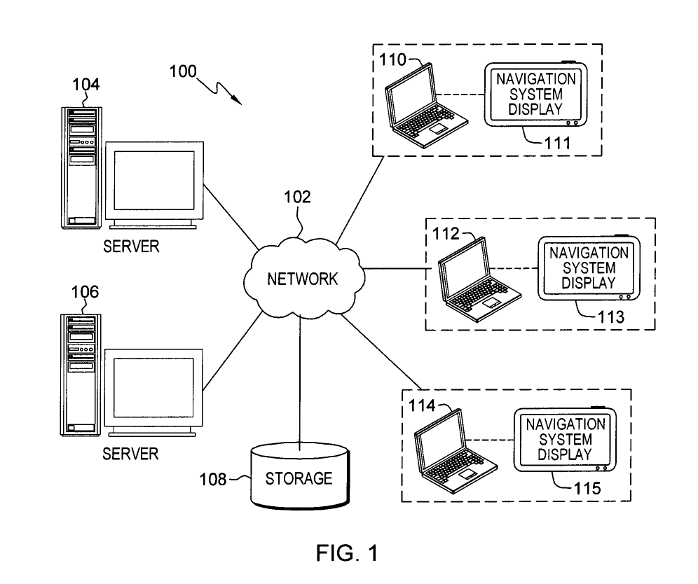

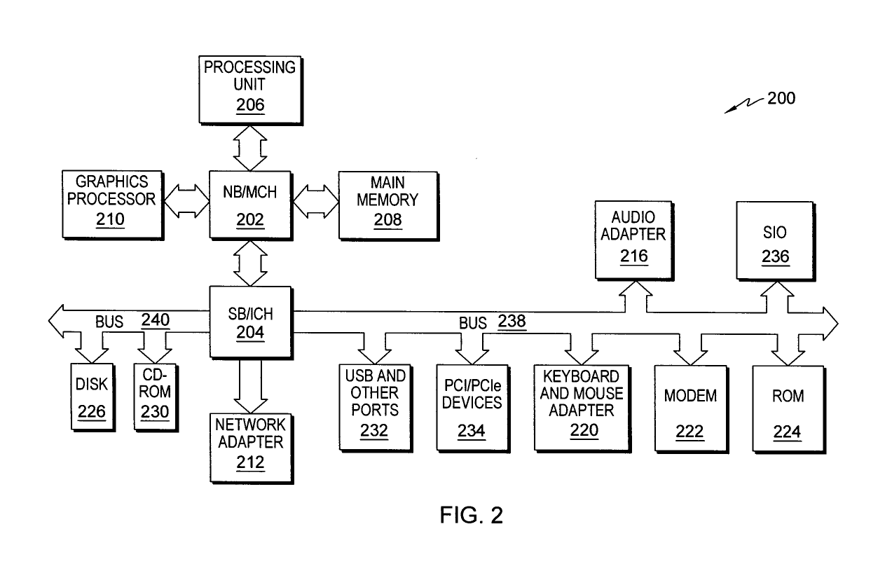

With reference to the figures, and in particular FIGS. 1-2, exemplary diagrams of data processing environments are initially provided in which illustrative aspects of the present invention may be implemented. Note in this regard that FIGS. 1-2 are only exemplary, and are not intended to imply any limitation with regard to the environments in which different aspects may be implemented. Many modifications to the depicted environments may be made.

Referring to FIG. 1, network data processing system 100 may include multiple computers, and a network 102. Network 102 may be any medium used to provide communications links between various devices and computers connected together within network data processing system 100. For instance, network 102 may include connections, such as wires, wireless communication links, fiber optic cables, etc.

In the depicted system, servers 104, 106 connect to network 102, along with a storage unit 108, and clients 110, 112, 114. Clients 110, 112, 114 may be, for example, a mobile device, such as a mobile phone, a tablet, a personal digital assistant (PDA), a remote navigation system, a wireless computer, etc. In operation, server 104 may provide data, such as boot files, operating system images, and applications to clients 110, 112, and 114, and further clients 110, 112, 114 may be clients to server 104 in one example only.

In one or more embodiments, clients 110, 112, and 114 may include an electronic calendar and travel facility such as described herein, in which (in part) data for the calendar(s) may be stored on server 104. In one or more embodiments, one or more of clients 110, 112, and 114 may include or have associated therewith navigation capabilities, such as available with existing navigation systems (such as GPS-based systems, GLONASS-based systems, cellphone tower triangular-based systems, etc.), and may include or be in communication with a navigation display 111, 113, 115, respectively.

Further, server 104 may provide different scheduling processes for events, such as meetings, in the calendars. Alternatively, depending on the implementation, calendar information may be stored at clients 110, 112, and 114. With this type of implementation, server 104 may provide services to allow clients 110, 112, and 114 to exchange calendar information related to events in their calendars, and receive travel notices and options as discussed herein. Note that network data processing system 100 may include fewer servers and clients, or additional servers, clients, or other devices (not shown).

In one or more embodiments, network data processing system 100 may incorporate, or utilize, the Internet, with network 102 representing a potentially worldwide collection of networks and gateways that use the Transmission Control Protocol/Internet Protocol (TCP/IP) suite of protocols to communicate with one another. As known, the Internet includes a backbone of high-speed data communication lines between major nodes or host computers, comprising millions of commercial, governmental, educational and other computer systems that route data and messages. Of course, network data processing system 100 may also be implemented as a number of different types of networks, such as for example, an intranet, a local area network (LAN), a wide area network (WAN), a wireless network, etc. FIG. 1 is intended as one example only, and not as an architectural limitation for the different illustrative aspects of the electronic calendaring disclosed herein.

Referring to FIG. 2, a block diagram of a data processing system is shown in which illustrative aspects of the present invention may be implemented. Data processing system 200 may be one example of a computer, such as server 104 or client 110 in the system of FIG. 1, and may include computer usable program code or instructions implementing processes such as disclosed herein.

In the depicted example, data processing system 200 includes a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the NB/MCH through an accelerated graphics port (AGP), for example.

In the depicted example, a local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system, such as a Microsoft™ Windows™ system (Microsoft and Windows are trademarks of Microsoft Corporation in the United States, other countries, or both). An object oriented programming system, such as the Java™ programming system, may run in conjunction with the operating system and provide calls to the operating system from Java™ programs or applications executing on data processing system 200. (Java™ and other Java™ based trademarks are trademarks of Sun Microsystems, Inc. in the United States, other countries, or both.)

Instructions for the operating system, the object-oriented programming system, and applications or programs may be located on storage devices, such as hard disk drive 226, and may be loaded into main memory 208 for execution by processing unit 206. The processes of the illustrative aspects discussed herein may be performed by processing unit 206 using computer implemented instructions, which may be located in a memory such as, for example, main memory 208, read only memory 224, or in one or more peripheral devices.

The hardware embodiments depicted in FIGS. 1-2 may vary depending on the desired implementation. Other internal hardware or peripheral devices, such as flash memory, equivalent non-volatile memory, or optical disk drives and the like, may be used in addition to or in place of certain hardware depicted in FIGS. 1-2. Also, the processes of the illustrative aspects described herein may be applied to other hardware environments, such as to a multiprocessor data processing system.

In one or more implementations, data processing system 200 may be a mobile device, and be generally configured with flash memory to provide non-volatile memory for storing operating system files and/or user-generated data. A bus system may include one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. Those skilled in the art should note that the depicted system examples of FIGS. 1-2, as well as other examples referenced herein, are not meant to imply architectural limitations. For example, as briefly noted, data processing system 200 may be implemented as part of a tablet computer, laptop computer, mobile telephone, personal digital assistant (PDA), wireless computer, vehicle navigation system, etc.

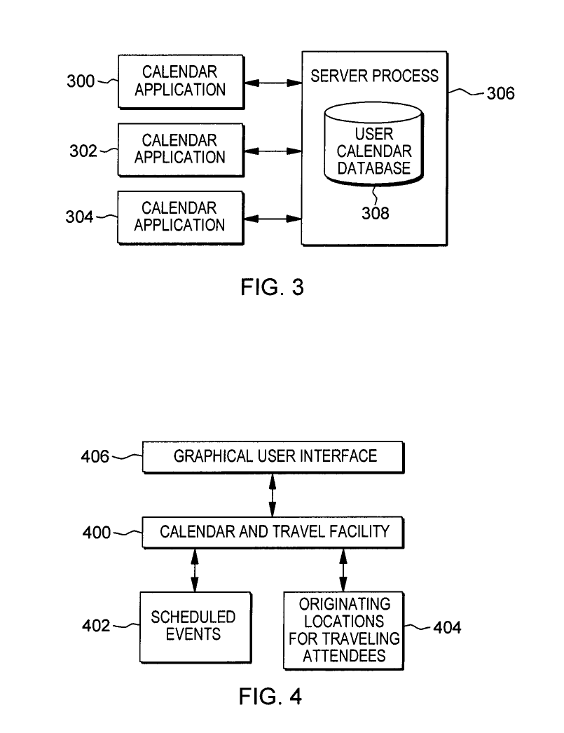

Referring to FIG. 3, a diagram illustrating one embodiment of an electronic calendar system used in scheduling or managing calendar appointments is provided, which may incorporate one or more aspects of the present invention. In this example, calendar applications 300, 302 and 304 may be client applications to a server process 306. These calendar applications may be, for example, stand-alone applications providing electronic calendar system functions. Alternatively, these calendar applications may be processes or applications integrated within one or more other applications or programs.

By way of example, calendar applications 300, 302, and 304 may be implemented using Microsoft™ Outlook™. These applications also may be implemented using IBM® Verse™. (IBM® and Verse™ are trademarks of International Business Machines Corporation in the United States, other countries, or both.) In yet another implementation, these applications may be web-based applications. When implemented using existing applications, calendar applications 300, 302, and 304 may be modified to include processes to manage calendar changes, in terms of time and location, for one or more attendees. In other implementations, these processes and changes may be managed on a server.

Depending on the particular implementation, calendar entries may be stored at the data processing system on which the calendar application executes. In one or more other implementations, the calendars for users may be stored in a database, such as user calendar database 308. When calendar applications 300, 302, and 304 store entries locally, server process 306 may serve to facilitate the exchange of calendar invitations for appointments. In this type of implementation, server process 306 might be an email server process.

By way of enhancement, when trying to schedule an event, it may be ideal if each attendee be at a same physical location for the event, such as a meeting. However, many peoples' schedules require them to travel extensively, and in such cases, it may be advantageous to track estimated arrival times at a meeting location of attendees traveling to the event.

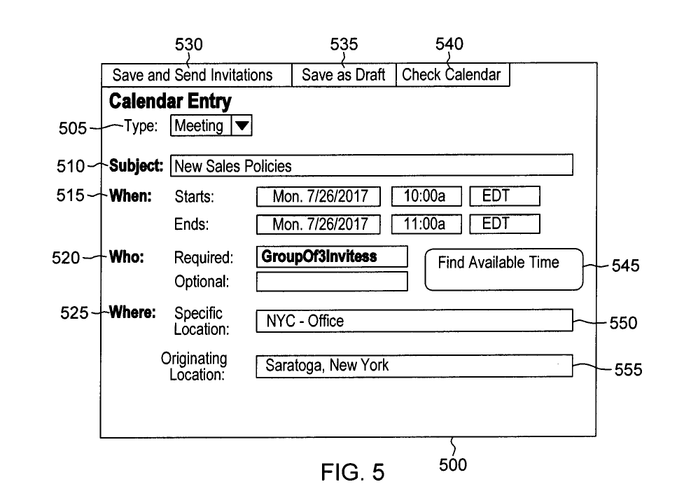

By way of further explanation, FIG. 4 depicts a diagram of an electronic calendar and travel facility 400, which includes (in part) a calendar application similar to calendar applications 300, 302 or 304 of FIG. 3. In this example, however, the calendar application is augmented with a travel application which may access scheduled events 402, as well as originating locations for multiple traveling attendees 404 for a scheduled event. In one or more implementations, the owner of a calendar event may use the electronic calendar and travel facility of FIG. 4 to view, via a graphical user interface 406, travel information resulting from or related to one or more attendees being travel-delayed to a scheduled meeting, as described herein.

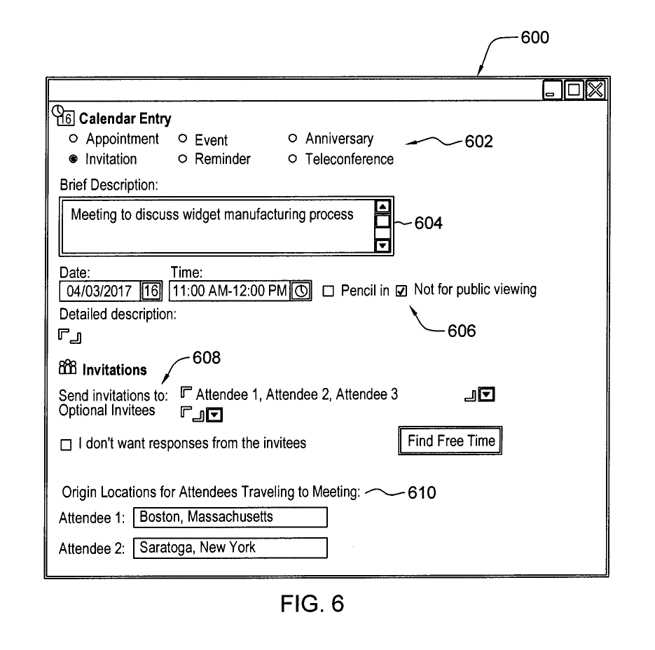

FIG. 5 depicts one example of a graphical user interface window 500 of an electronic calendar and travel system, in accordance with one or more aspects of the present invention. Graphical user interface window 500 may be displayed to a user, for instance, a scheduler, of the electronic calendar system through, for example, a monitor or other display device. Using graphical user interface window 500, a scheduler may initiate scheduling (for instance, create or manage) a new calendar event in the electronic calendar system. As shown, graphical user interface window 500 may include an area 505 for the user to select the type of event, an area 510 for the user to input a subject of the event, an area 515 for the user to input or modify a tentative time for the event, an area 520 for the user to indicate attendees selected for the event, and an area 525 for the user to specify a location 550 for the event. Additionally, the graphical user interface window 500 may include a button 530 to save the event in the electronic calendar system, and to send invitations to indicated attendees, a button 535 to save the event as a draft, and a button 540 allowing the user to check their own schedule stored in the electronic calendar system.

A user may specify the attendees for the event in the graphical user interface window 500 by, for instance, inputting the name of a predefined group. The predefined group may include an e-mail address, a system nickname, and/or account information for each of the attendees associated with the predefined group. Additionally, or alternatively, a user may specify the attendees for the event in window 520 individually, using an e-mail address, a system nickname, and/or other account information.

The graphical user interface window 500, in this example, includes a “find available time” button 545, which may trigger the electronic calendar system to perform the function of searching availability associated with each of the attendees' specified for the event to determine a number of periods of availability. The periods of availability may be periods of time during which a significant number of the attendees are determined to be available. The electronic calendar system may be configured to find a specified number of periods of availability (e.g., then periods of availability that maximize the number of attendees that are available during at least one of the periods of availability) or, alternatively, to find a smallest number of periods of availability, such that each of the attendees is available during at least one of the periods of availability.

Additionally, as described herein, the meeting location 550 may be specified, as well as an originating location 555 for the owner attendee scheduling the calendar event. This assumes that the owner attendee will be traveling to the meeting location. Further, each invitee to the meeting attending the meeting may be requested to designate an originating location when traveling to the meeting location prior to the meeting. Note that in this regard, traveling to the meeting means traveling a geographical distance to arrive at the meeting location, such as, for instance, by driving to the meeting location from the originating location.

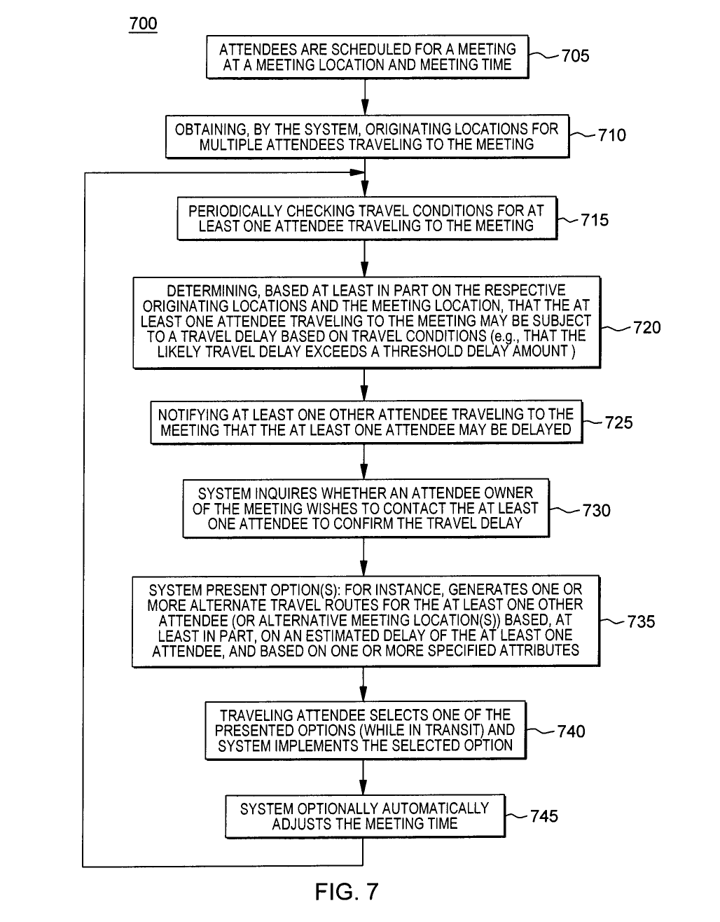

FIG. 6 depicts a further example of a graphical user interface window 600, illustrating one of many possible calendar application entry pages, in accordance with one or more aspects of the present invention. The calendar entry page depicted in the figures may be a modified pages from, for instance, an IBM® Verse™ electronic calendar system. This figure is only exemplary, and is not intended to assert or imply any limitation with regard to the environments in which different aspects of the present invention may be implemented. There are other calendar applications, rather than the depicted application, with which aspects of the illustrated embodiments may be implemented.

Referring to FIG. 6, calendar entry page 600 is pictured with invitation option 602 selected. Brief description text box 604 indicates that the subject matter of the event is a meeting. Box 606 entitled “not for public viewing” is selected in forming the calendar application that the brief description, as well as other information, may be private information. Responsive to whether box 606 is selected, the calendar application may provide a minimum amount of information necessary to special request service vendors. The invitation list of invitees or attendees 608 lists all of the attendees to the meeting. List 608 indicates that at least attendee 1, attendee 2, and attendee 3 are intended to be attendees of the meeting. Responsive to originating locations being provided for attendee 1, and attendee 2, the originating locations for attendees traveling to the meeting 610 may be identified by the calendar application. In this example, it may be assumed that attendee 3 will already be at the meeting location prior to the meeting time, with only attendee 1 and attendee 2 traveling to arrive at the meeting location at the meeting time.

In the above example, attendee 1 and attendee 2 may be traveling at the same time to arrive at the meeting on time, and one of the attendees, for instance, attendee 1, experiences a travel delay due, for instance, to traffic conditions on that attendee's travel route. In view of this, attendee 1 may be delayed by for a period of time, such as an hour, before reaching the meeting location. In view of this, the electronic calendar and travel facility disclosed herein may identify the likely travel delay for attendee 1, and provide attendee 2 and/or attendee 3 (or the other meeting owner), with an update notification. Additionally, the facility provides one or more options for the other traveling attendee. For instance, in one or more implementations, attendee 2 may be presented with an option to take a different travel route to the meeting location. For example, attendee 2 may be traveling or intending to travel on a toll road to timely arrive at the meeting location at the original meeting time. Once attendee 2 knows that attendee 1 may be delayed, attendee 2 may decide to select a system presented option for a non-toll travel route to the meeting location, thereby saving attendee 2 money while still arriving at a time before or commensurate with attendee 1. In combination with this, or alternatively, the system could provide attendee 2 with an alternate travel route based on one or more other specified attributes than cost savings. For instance, attendee 2 might specify a more scenic alternate travel route for arriving at the meeting by or before when attendee 1 is now anticipated to arrive at the meeting location.

Disclosed herein in one or more aspects is a calendar and travel facility which monitors travel conditions, and based on the monitoring, presents changes in real-time while attendees to a meeting are in transit. This dynamic facility may, in one or more embodiments, advantageously save travel costs and/or frustration of the traveling attendees once the travel delay has been detected and shared with other traveling attendees. Note that the facility disclosed herein does not need to rely on knowing the current position of each traveling attendee while they are in transit to the meeting, as such an approach may be unacceptable to one or more attendees.

Generally stated, in one or more aspects, a computer-implemented method, system, and computer program product are disclosed herein which provide an electronic calendaring and travel facility. The computer-implemented method includes receiving, by an electronic system, a meeting time and meeting location for a meeting, and ascertaining, by the electronic system, that multiple attendees to the meeting are traveling to the meeting. The ascertaining may include obtaining originating locations for the multiple attendees traveling to the meeting. The method further includes determining, based at least in part on the respective originating locations and the meeting location, that at least one attendee traveling to the meeting is subject to a travel delay based on one or more travel conditions, and is predicted to be delayed to the meeting, and where present, notifying at least one other attendee traveling to the meeting that the at least one attendee is predicted to be delayed. One or more alternate travel routes may be generated for the at least one other attendee based, at least in part, on an estimated delay of the at least one attendee, and based on one or more specified attributes for the alternate travel route(s).

In one or more implementations, the one or more specified attributes may include a lower cost travel route to the meeting location. For instance, the specified attribute may include a non-toll travel route. In one or more other implementations, the one or more specified attributes may include a more scenic travel route to the meeting location than a current travel route. For instance, the specified attribute may avoid highways. In one or more further embodiments, the one or more specified attributes for the alternate travel route(s) may include one or more user-specified attributes for the travel route. That is, the individual user or attendee traveling to the meeting and to receive the alternate travel route information may preprogram or otherwise specify the attribute(s) to be used in selecting the alternate travel route.

In one or more implementations, the determining may include monitoring the travel conditions for the at least one attendee along a likely route of travel from the respective originating location to the meeting location, and periodically determining an estimated arrival time of the at least one attendee at the meeting location. In one or more embodiments, the multiple attendees may be driving to the meeting from different originating locations, and the travel conditions being monitored may include traffic conditions along the likely route of travel of the at least one attendee, where the traffic conditions may be obtained from a traffic monitoring service.

By way of example, the generating may include determining a current physical location of the at least one other attendee and based, at least in part, on the location, generating the alternate travel route(s) to the meeting location using the one or more specified attributes for the alternate travel route(s).

In one or more implementations, the notifying may be based on determining that the travel delay of the at least one attendee exceeds a set threshold delay amount. For instance, the set threshold may be 15 minutes or more, and if desired, may be user-adjustable.

In one or more implementations, the generating may further include determining an alternate meeting location for the meeting based, at least in part, on the estimated delay of the at least one attendee and, for instance, likely current locations of the multiple attendees traveling to the meeting. For instance, in one or more embodiments, the attendee owner of the meeting may be presented with an option to contact the delayed attendee(s) to confirm the delay, and once confirming the travel delay, the system may generate an alternative meeting location(s).

In one or more further embodiments, alternative arrival times and meeting locations for the meeting may be preset by the scheduler of the meeting, or the scheduler could preset that the meeting location is unalterable, along with the meeting time. For instance, if there are a large number of attendees, then is it is likely that the meeting time and location would be unmodified.

In one or more embodiments, the system may allow for presetting of the type of venue for a meeting. For instance, where the meeting is a business meeting for a company A, the electronic system may be allowed to suggest other meeting locations, provided that those other meeting locations are other locations of company A. That is, the meeting might need to be onsite at one of the locations of company A.

In general, the calendaring and travel facility disclosed herein allows for coordinating travel, and rescheduling and/or relocating a meeting based on travel times and changes to travel times resulting from unexpected travel delays experienced by one or more attendees to the meeting. The rescheduling could include providing alternate travel routes for one or more attendees not experiencing the travel delay, as well as suggesting different meeting locations or meeting times.

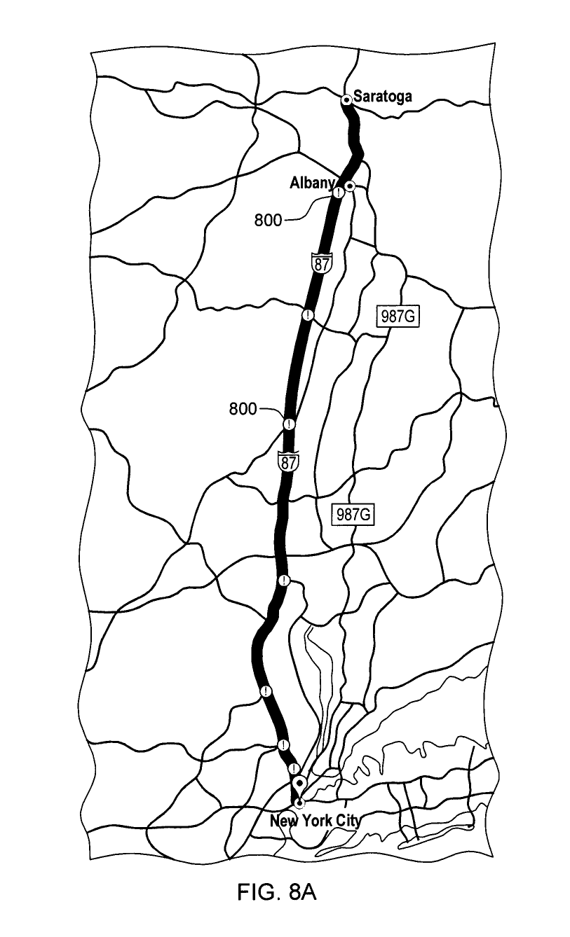

FIG. 7 depicts one embodiment of a calendar and travel monitoring process 700, in accordance with one or more aspects of the present invention. In this embodiment, attendees are scheduled for a meeting at a meeting location and a meeting time 705. For instance, a meeting owner or scheduler of the meeting sets the meeting location and meeting time, and provides meeting invites using a calendaring system to the desired participants. As part of the invite, one or more of the attendees indicate to the electronic system that they will be traveling to the meeting location to arrive at the meeting by providing an originating location for traveling to the meeting 710.

Prior to start of the meeting, the electronic system periodically checks travel conditions for at least one attendee traveling to the meeting 715. For instance, where appropriate the system may assume that the at least one attendee is driving to the meeting from the originating location to arrive at the meeting location at approximately the meeting time. As such, the system may determine a likely travel route for the at least one attendee, and evaluate traffic conditions along the likely travel route. In this manner, the system does not require an actual location for the at least one attendee, but rather, the system is able to estimate a current location based on traffic conditions (for instance, available through various traffic services) and the originating and meeting locations.

Processing determines, based at least in part, on the respective originating location and the meeting location, that the at least one attendee traveling to the meeting may be subject to a travel delay based on one or more travel conditions 720. For instance, this determining may involve the system determining that there is likely a travel delay that exceeds a threshold delay amount, for instance, 15 minutes or more.

Where a travel delay is identified, the system notifies at least one other attendee traveling to the meeting that the at least one attendee may be delayed 725, and may inquire whether the attendee owner of the meeting wishes to contact the at least one attendee to confirm the travel delay 730. In this example, the at least one other attendee traveling to the meeting may be the attendee owner of the meeting. Based on the travel delay, the system may present one or more options. For instance, the system may generate one or more alternate travel routes for the at least one other attendee based, at least in part, on an estimated delay of the at least one attendee, and based on one or more specified attributes, for instance, for the alternate travel routes 735. In one particular embodiment, the specified attributes may include a lower cost travel route to the meeting location than a current travel route. For instance, the attributes may require that the alternate travel route avoid toll roads in order that the traveling attendee may reduce costs for arriving at the meeting location at the delayed meeting time. As noted above, other options could also be presented to, for instance, the owner attendee of the meeting to reschedule the meeting time, or potentially reschedule the meeting location based on any specified attributes for the meeting location.

As illustrated in FIG. 7, the traveling attendee(s) may select one of the presented options while in transit 740, and the system implements the selected option. The system may optionally automatically adjust the meeting time in the attendees' calendars 745, and continue to periodically check travel conditions for the at least one attendee traveling to the meeting. Note that in one or more embodiments, the system may check travel conditions for each traveling attendee to the meeting. Where the meeting includes more than two attendees, then the system may present the at least one other traveling attendee with the option to confirm the meeting location and time, and stay on the current travel route to arrive on time to the meeting, for instance, where there is a third or more attendees who are expected to arrive timely at the meeting location.

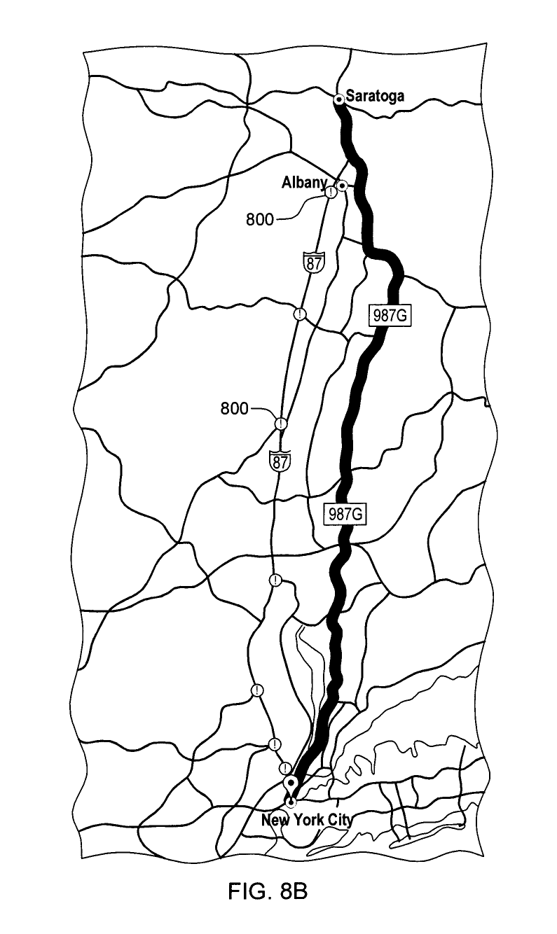

FIGS. 8A & 8B depict an example of the above processing, wherein attendee 2 is traveling from Saratoga Springs to New York City for the scheduled meeting, with Saratoga Springs, New York being the originating location, and New York City being the meeting location. While in transit, for instance, before reaching Albany, N.Y., the system identifies a travel delay for attendee 1, who may be traveling, in the example presented, from Boston, Mass. to New York City. Based upon an estimated delay for attendee 1, for instance of an hour or more, the system may present attendee 2 with the option to avoid the current route down the thruway between Albany and New York City, which includes tolls 800, and take a more scenic route, such as the Taconic Parkway, from Albany to New York City, to arrive at the meeting location at about the same time as the delayed attendee 1 is now projected to arrive at the meeting location. In this way, the system facilitates dynamic adjustment by the attendees traveling to the meeting based upon one or more of the attendees experiencing a delay. In the case of FIGS. 8A & 8B, the system allows attendee 2 to save money by taking a non-toll option, as well as taking a more scenic option, for arriving at the meeting on time with attendee 1. Note that in this example (of FIGS. 5 & 6), attendee 3 is assumed to already be at the meeting site, and thus, alternative travel route for attendee 3 is not required. In one or more implementations, attendee 3 may also be advised of the travel delay experienced by attendee 1 in order to allow attendee 3 to use the time productively.

Advantageously, the calendaring and travel facility disclosed herein allows multiple attendees to be notified should one of the attendees experience a travel delay, with the information being automatically shared in order to save time and potentially costs for attendees traveling to a meeting, for example, where the meeting is likely to be delayed. The system assumes that the calendaring programs used by the attendees to the meeting, particularly the traveling attendees, are able to share their starting or originating location, and if needed, a likely route each attendee would take. This information may then be shared with the navigation or travel facility. Traveling attendees to the meeting may use their navigation system to initially select the best route for the user subject to the constraint of arriving at the meeting location at the meeting time.

The facility disclosed herein periodically recalculates the estimated travel time for each traveling attendee, and if the travel time or arrival time of the attendee increases by more than a set threshold, for instance, 15 minutes or more, then the facility may present other traveling attendees and/or the meeting owner with options as to how to proceed. The options may include relocating the meeting, or keeping the current location and notifying attendees that the meeting will start later. Where the meeting may be relocated, the meeting owner might need to perform setup when scheduling the meeting. Several alternatives are possible. For instance, the meeting scheduler may require that the meeting be held at the specified meeting location, with no relocation being possible. Alternatively, the meeting may be scheduled for a specific venue, but several alternative locations are also provided. For instance, if this is a company A meeting with a vendor, then the scheduler may be willing to proceed with the meeting at any company A location in a given geographic area. Still further, the meeting scheduler could specify that the meeting be held at a specific type of venue. For instance, the scheduler could specify a type of coffee shop, or restaurant type. In this case, existing search facilities could be used to find such venues which are in an appropriate location for the meeting.

Where the current meeting location is to be maintained, the system may notify attendees that the meeting will start later, and for one or more other traveling attendees, recalculate a travel route to the location. This recalculating may involve searching for a route which would be less expensive for the traveling attendee who is not delayed. For instance, this may include directing the attendee from a faster, toll route to a somewhat slower, non-toll route.

As noted, the facility disclosed herein does not require or assume that the meeting owner, or other attendees, have current position on each attendee traveling to the meeting. This is because it is assumed that such information may be an unacceptable invasion of privacy. As a refinement, where the system detects that an attendee is likely delayed in travel due to the attendee's originating location and likely route of travel, the system may allow a meeting owner, or other traveling attendee, to contact the delayed attendee to find out if the delay is real, and if so, the amount of delay. For instance, the system might prompt a user with “It looks like attendee 1 is encountering a traffic delay, and may be 30 minutes late to the scheduled meeting. Would you like to call the attendee to check?” After the call completes, the system may then present the meeting owner or travelling attendees with options such as above.

One or more aspects may relate to or use cloud computing.

It is understood in advance that although this disclosure includes a detailed description on cloud computing, implementation of certain teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

A cloud computing node may include a computer system/server, such as the one depicted in FIGS. 1-2, wherein the computer system/server may be practiced in distributed cloud computing environments where tasks are performed by remote processing devices that are linked through a communications network. In a distributed cloud computing environment, program modules may be located in both local and remote computer system storage media including memory storage devices. The depicted computer system/server is capable of being implemented and/or performing any of the functionality set forth hereinabove.

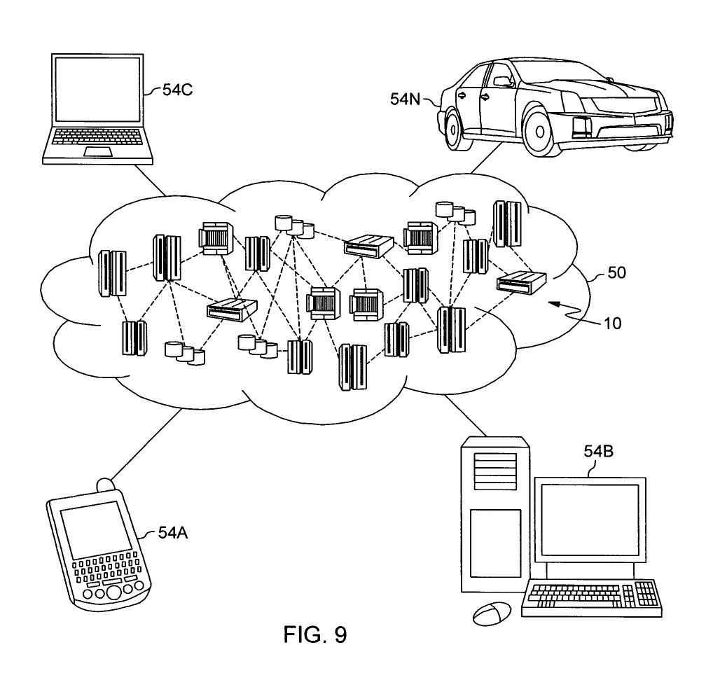

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

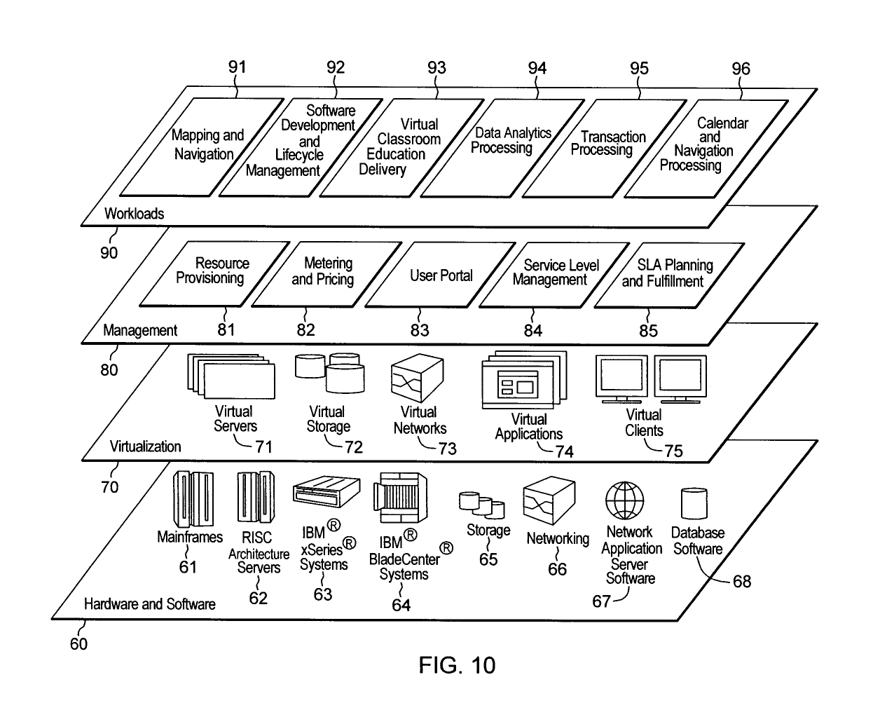

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and calendar and navigation processing 96.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A computer-implemented method comprising:
receiving, by an electronic system, a meeting time and meeting location for a meeting;
ascertaining, by the electronic system, that multiple attendees to the meeting are traveling to the meeting, the ascertaining including obtaining originating locations for the multiple attendees traveling to the meeting;
determining, based at least in part on the respective originating locations and the meeting location, that at least one attendee traveling to the meeting is subject to a travel delay based on one or more travel conditions, and is predicted to be delayed to the meeting;
notifying at least one other attendee traveling to the meeting that the at least one attendee is predicted to be delayed to the meeting; and
generating one or more alternate travel routes for the at least one other attendee based, at least in part, on an estimated delay of the at least one attendee, and based on one or more specified attributes for the alternate travel route(s).

2. The computer-implemented method of claim 1, wherein the one or more specified attributes comprise a lower cost travel route to the meeting location than a current travel route.

3. The computer-implemented method of claim 1, wherein the one or more specified attributes comprise a more scenic travel route to the meeting location than a current travel route.

4. The computer-implemented method of claim 1, wherein the one or more specified attributes for the alternate travel route(s) include one or more user-specified attributes for the alternate travel route(s).

5. The computer-implemented method of claim 1, wherein the determining comprises periodically determining an estimated arrival time of the at least one attendee at the meeting location based, at least in part, on a likely route of travel from the respective originating location to the meeting location.

6. The computer-implemented method of claim 5, wherein the multiple attendees are driving to the meeting and the one or more travel conditions comprise traffic flow conditions along the likely route of travel of the at least one attendee.

7. The computer-implemented method of claim 1, wherein the generating includes determining a location of the at least one other attendee based on the determining that the at least one attendee is predicted to be delayed, and based, at least in part, on the location, generating the alternate travel route(s) to the meeting location using the one or more specified attributes for the alternate travel route(s).

8. The computer-implemented method of claim 1, wherein the notifying is based on determining that the travel delay of the at least one attendee exceeds a set threshold delay amount.

9. The computer-implemented method of claim 1, wherein the generating further comprises determining an alternate meeting location for the meeting based, in part, on the estimated delay of the at least one attendee, and likely current locations of the multiple attendees traveling to the meeting.

10. The computer-implemented method of claim 1, wherein the generating further comprises determining an alternate meeting time for the meeting based, at least in part, on the estimated delay of the at least one attendee.

11. A system of electronic calendaring and travel monitoring, the system comprising:
a memory; and
a processing circuit communicatively coupled with the memory, wherein the system performs a method comprising:
receiving a meeting time and meeting location for a meeting;
ascertaining that multiple attendees to the meeting are traveling to the meeting, the ascertaining including obtaining originating locations for the multiple attendees traveling to the meeting;
determining, based at least in part on the respective originating locations and the meeting location, that at least one attendee traveling to the meeting is subject to a travel delay based on one or more travel conditions, and is predicted to be delayed to the meeting;
notifying at least one other attendee traveling to the meeting that the at least one attendee is predicted to be delayed to the meeting; and
generating one or more alternate travel routes for the at least one other attendee based, at least in part, on an estimated delay of the at least one attendee, and based on one or more specified attributes for the alternate travel route(s).

12. The system of claim 11, wherein the one or more specified attributes comprise a lower cost travel route to the meeting location than a current travel route.

13. The system of claim 11, wherein the one or more specified attributes comprise a more scenic travel route to the meeting location than a current travel route.

14. The system of claim 11, wherein the one or more specified attributes for the alternate travel route(s) include one or more user-specified attributes for the alternate travel route(s).

15. The system of claim 11, wherein the determining comprises periodically determining an estimated arrival time of the at least one attendee at the meeting location based, at least in part, on a likely route of travel from the respective originating location to the meeting location.

16. The system of claim 15, wherein the multiple attendees are driving to the meeting and the one or more travel conditions comprise traffic flow conditions along the likely route of travel of the at least one attendee.

17. The system of claim 11, wherein the generating includes determining a location of the at least one other attendee based on the determining that the at least one attendee is predicted to be delayed, and based, at least in part, on the location, generating the alternate travel route(s) to the meeting location using the one or more specified attributes for the alternate travel route(s).

18. The system of claim 11, wherein the notifying is based on determining that the travel delay of the at least one attendee exceeds a set threshold delay amount.

19. A computer program product for electronic calendaring and travel monitoring, the computer program product comprising:
a computer readable storage medium readable by a processing circuit and storing instructions for execution by the processing circuit for performing a method comprising:
receiving a meeting time and meeting location for a meeting;
ascertaining that multiple attendees to the meeting are traveling to the meeting, the ascertaining including obtaining originating locations for the multiple attendees traveling to the meeting;
determining, based at least in part on the respective originating locations and the meeting location, that at least one attendee traveling to the meeting is subject to a travel delay based on one or more travel conditions, and is predicted to be delayed to the meeting;
notifying at least one other attendee traveling to the meeting that the at least one attendee is predicted to be delayed to the meeting; and
generating one or more alternate travel routes for the at least one other attendee based, at least in part, on an estimated delay of the at least one attendee, and based on one or more specified attributes for the alternate travel route(s).

20. The computer program product of claim 19, wherein the one or more specified attributes comprise a lower cost travel route to the meeting location than a current travel route.
